(19) United States
(12) Patent Application Publication
(10) Pub. No.: US 2026/0110219 A1
(43) Pub. Date: Apr. 23, 2026

(54) Method and device for making a hole in a golf green

(71) Applicant: KSAB Utemiljö AB, VÄSTERÅS (SE)

(72) Inventor: Carl Gustav FALK, SOLLENTUNA (SE)

(21) Appl. No.: 19/424,347

(22) Filed: Dec. 18, 2025

(30) Foreign Application Priority Data
Jun. 30, 2023 (SE) 2350822-9

(51) Int. Cl. E21B 7/02; A63B 57/50; E21B 25/00; A63B 57/40

(52) U.S. Cl. CPC E21B 7/028; A63B 57/50; E21B 25/005; A63B 57/40

(57) ABSTRACT

A device and method for making a hole in a golf green. The device has longitudinal, radial, and angular directions and includes a cutting cylinder, a structure, a weight, and a weight-propulsion device. The cutting cylinder has an axis parallel to the longitudinal direction and an open end freely movable longitudinally. The structure includes a guide defining a weight path with first and second endpoints. The weight engages the guide and moves along this path. The propulsion device drives the weight reciprocally between the endpoints so the weight strikes the cutting cylinder, urging it longitudinally. The propulsion device includes a first electric motor, a spring, and a force-mediating device. The motor rotates a drive axle. During a first stage, the force-mediating device engages the axle with the spring to store potential energy. In a second stage, it disengages the axle, allowing the spring to release the energy to accelerate the weight toward the cutting cylinder.

### BACKGROUND

The various embodiments of the invention relate to a method and a device for making a hole in a golf green. Embodiments of the invention also relate to a method and a device for moving a hole in a golf green from a second location to a first location.

In the game of golf, the object is to get the golf ball in a hole using as few strokes as possible. The hole in question is normally located in an area with short-kept grass called a “green”. Due to the wear on the grass of such a golf green during play, by players walking around and playing near the hole, the hole is conventionally moved around the green regularly. It may also be the case that hole positions presenting different levels of playing difficulty are desirable in various situations, such as during golf competitions.

When the hole is moved from the second to the first location, a new hole must be made in the first hole location. This typically entails lifting a cylinder of soil and grass, leaving a cylindrical hole in the green ground. The lifted cylinder can then be placed in the old hole, at the second location, providing the filled-in hole at the second location with an intact grass surface. This way, the hole can be moved frequently without damaging the green.

However, conventional hole cutters suffer from various problems.

The hole to be cut is normally about 20 cm deep and 10 cm of diameter. Some conventional cutters use a combination of twisting and pushing on a circular-cylindrical cutting blade, which is worked downwards into the soil until the desired depth is reached. This process may very well take several minutes to finalize, and it would be desirable to shorten this time.

Also, the process of releasing the lifted soil cylinder into the old hole, which is normally achieved via a manually actuated lever, is time consuming.

Since such hole cutting devices are used outdoors, under rough conditions and for prolonged periods of time, it is also important that they are built from sturdy components that can provide reliable operation for long periods of time. At the same time, it is important that a hole cutter is not too heavy or bulky, so that it can be handled be greenkeepers when out and about on the golf course.

Swedish application SE 2050971-7 describes a green hole cutter and a method for cutting a hole in a green. The green hole cutter comprises a weight that is driven by a propulsion device, as well as a soil expulsion piston. The weight is selectively used to drive a hole cutting cylinder or the soil expulsion piston.

### SUMMARY

In one aspect, the invention relates to a device for making a hole in a golf green, the device having a longitudinal direction, a radial direction and an angular direction, the device comprising:

a cutting cylinder with an axis parallel to the longitudinal direction and an open end being freely movable along the longitudinal direction;

a structure, comprising guide means defining a weight path having a first endpoint and a second endpoint;

a weight, in engagement with said guide means to be guidedly movable along said weight path; and

a weight propulsion device, arranged to propel the weight reciprocally along said weight path between said first endpoint and said second endpoint so that the weight strikes against the cutting cylinder when the weight is at a location along said weight path, in turn urging the cutting cylinder in the longitudinal direction.

The weight propulsion device further comprises:

a first electric motor, arranged to drive a drive axle to rotate about a rotary axis under influence of a rotary force provided by the first electric motor;

a spring means, being arranged to be activated, in a first stage and against a spring force of the spring means, whereby a potential energy is stored in the spring means; and in a second stage to release the potential energy by relaxing the spring means and to thereby transform the potential energy into kinetic energy of the weight striking against the cutting cylinder; and

a force mediating device, arranged to, during the first stage, engage the drive axle with the spring means to mediate the rotary force to the spring means in turn activating the spring means; and, during the second stage, disengage the drive axle from the spring means to allow the spring means to release the potential energy independently of a rotary movement of the drive axle.

In some embodiments, the force mediating device comprises:

a crank, arranged to pivot about said rotary axis; and

a linear force device, connected to the crank at a distance from the rotary axis.

In some embodiments, the crank is arranged to convert said rotary force into a linear force applied to the linear force device.

In some embodiments, the linear force device is arranged to apply a linear force to the spring means during the first stage to activate the spring means.

In some embodiments, the linear force device is a pulling device, arranged to apply a pulling force to the spring means during the first stage to activate the spring means.

In some embodiments, the force mediating device further comprises

a drive pin, the drive pin being eccentrically arranged in relation to the rotary axis and arranged to be forced, by the drive axle, to move along a circular path in a plane perpendicular to the rotary axis, the drive pin further being arranged to push the crank, thereby forcing the crank to pivot about the rotary axis.

In some embodiments, the first electric motor is arranged to activate the spring means in the first stage by moving the drive pin, in turn pushing the crank, in turn generating said linear force.

In some embodiments, the spring means is arranged to, during the second stage, apply a linear force to the linear force device in turn applying the linear force to the crank, the crank as a result pivoting ahead the drive pin about the drive axis.

In some embodiments, the spring means comprises a spiral spring arranged to be compressed or elongated during the first stage, and/or a gas spring.

In some embodiments, the spring means is arranged along the weight path, such as around the weight path.

In some embodiments, a total longitudinal direction weight amplitude is between 50 and 200 mm, such as between 70 and 120 mm, and/or wherein a total longitudinal direction weight amplitude is at the most 150 mm, such as at the most 100 mm.

In some embodiments, the device further comprises a soil expulsion piston, arranged to be activated to drive out a soil cylinder out from the cutting cylinder.

In some embodiments, the soil expulsion piston is a hydraulic piston.

In some embodiments, the device further comprises a hydraulic pump driven by a second electric motor.

In some embodiments, the soil expulsion piston is provided with pressurized hydraulic fluid, such as oil, by said hydraulic pump.

In some embodiments, the hydraulic pump is arranged to pressurize the hydraulic fluid when driven by the second electric motor, and to allow the pressure of the hydraulic fluid to decrease, preferably to atmospheric pressure, when not driven by the second electric motor.

In some embodiments, the first motor and the second motor are one and the same.

In some embodiments, the first motor is arranged to only drive the drive axle when driving in a first direction and to only drive the hydraulic pump when driving in a second direction.

In some embodiments, the device further comprises a battery, arranged to power the first motor and/or the second motor.

In another aspect, the invention relates to a method for making a hole in a golf green, the method comprising:

a) providing a device according to any preceding claim;

b) positioning said device in a first location on the golf green oriented so that its longitudinal direction is vertical;

c) activating the weight propulsion device to move the weight reciprocally and as a result repeatedly striking the cutting cylinder so that the cutting cylinder by each stroke is driven down into the ground; and

d) when a desired hole depth is reached, lifting the cutting cylinder upwards, thereby removing a resulting soil cylinder from the hole.

In another aspect, the invention relates to a method for moving a hole in a golf green from a second location to a first location, comprising said steps and further comprising the additional steps of:

e) positioning the device at the second location, at which a hole already exists in the ground; and

f) activating a soil expulsion device of the device so that a soil expulsion piston of the device pushes the soil cylinder our from the cutting cylinder and into the existing hole.

### DESCRIPTION OF THE DRAWINGS

In the following, the invention will be described in detail, with reference to exemplifying embodiments of the invention and to the enclosed drawings, wherein:

FIG. 1a shows a device for making a hole in a golf green, both in a vertical cross-section and in a first state;

FIG. 1b corresponds to FIG. 1a but shows the device in a second state;

FIGS. 2a and 2b show respective side views of a weight propulsion mechanism of a device for making a hole in a golf green;

FIGS. 3a-3d correspond to FIG. 2b, but show the weight propulsion mechanism in a first, second, third and fourth state;

FIG. 4 shows a soil expulsion mechanism of a device, the device being arranged for making a hole in a golf green;

FIG. 5 is a top view of a gree;

FIG. 6 is a flowchart illustrating a method; and

FIG. 7 shows a motor driving aggregate.

All Figures share the same reference numerals for the same parts.

### DETAILED DESCRIPTION

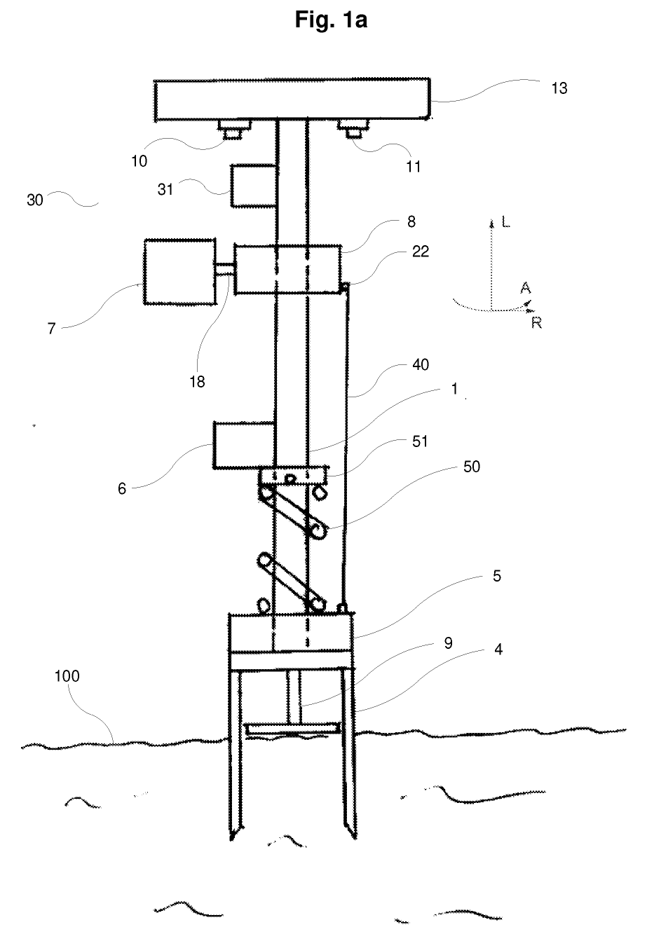

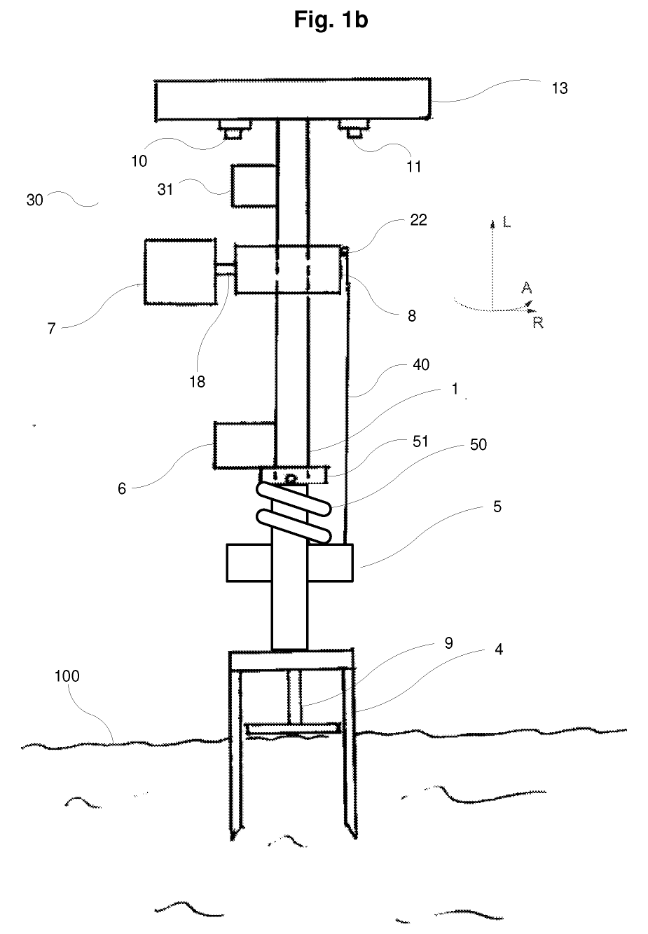

FIGS. 1a and 1b show a device 30 for making a hole in a golf green 100, according to one embodiment. The device 30 is associated with a longitudinal direction L, a radial direction R and an angular direction A, together forming a polar coordinate system.

The device 30 is generally arranged for use in the upright orientation shown in FIGS. 1a and 1b, with the longitudinal direction L vertically oriented or at least substantially vertically oriented (depending on any sloping green 100 surface, for instance). If not otherwise stated herein, the terms “downwards”, “upwards” etc. relate to the operating orientation shown in FIGS. 1a and 1b, where down in FIGS. 1a and 1b corresponds to “down” in reality. However, “down” may mean “plumb”, “perpendicular to the green 100 surface” or something therebetween. Generally, the weight 5 (see below) will move vertically or at least substantially vertically during operation.

The device 30 generally comprises a cutting cylinder 4, having a cylinder axis that runs in parallel to said longitudinal direction L and an open lower end.

The cutting cylinder 4 is arranged to be driven down into the soil on the green 100 by a driving force being applied onto the cutting cylinder 4 from a top side of the cylinder 4. This downwards driving direction is the downwards direction in FIGS. 1a and 1b.

In order to be able to cut down into the soil, the open lower end of the cutting cylinder 4 may be provided with a sharp cutting edge. It may be manufactured from a suitable metal material, and in particular the cutting edge may be made from a steel quality having high abrasive resistance.

The cutting cylinder 4 may have a circular cylindrical shape, so as to achieve a circular hole in the green 100.

An internal cylinder height (in the longitudinal direction L) of the cutting cylinder 4, being capable of holding a cylinder-shaped piece of cut soil, may at least correspond to the depth of a golf hole, which is at least 4.00 inches (10.2 cm). Preferably, the internal cylinder height of the cutting cylinder 4 is at least 15 cm, or even at least 20 cm. The cutting cylinder 4 may be provided with depth-limiting means, to stop the penetration of the cutting cylinder 4 when a user-defined cutting depth, such as 7.50 inches (19.1 cm) has been reached. Such depth-limiting means may be implemented in many different ways, such as selecting and mounting one from a collection of at least two available cutting cylinders 4 each having a respective internal cylinder space height corresponding to the desired cutting depth, or by providing a movable cutting-limiting mechanism, such as a plate, that can be set into one of several fixed or continuously adjustable positions.

The cutting cylinder 4 may be provided with through holes or other suitable ventilation openings at its upper end, allowing air to escape from the cutting cylinder 4 as its opposite lower end penetrates the soil.

The device 30 comprises a weight 5, which is used to drive the cutting cylinder 4 down into the soil by the weight 5 repeatedly striking with force onto the cutting cylinder 4.

The device 30 comprises a rigid structure, comprising guide means defining a weight path having a first endpoint and a second endpoint. In the embodiment illustrated in the Figures, this is exemplified by the weight 5 being provided with a central hole receiving a metal pole 1 running along the device 30 in the longitudinal direction L. In this case, the structure is the pole 1. The weight 5 is slidingly engaged with the pole 1 so that the weight can freely move up and down, along the longitudinal direction L, along the pole, towards and away from the cutting cylinder 4. The rigid structure may also be rigidly connected to the cutting cylinder 4.

It is understood that the pole 1 constitutes a guide means arranged so that the weight 5 is guidedly movable along said weight path. It is understood that such a weight path, mechanically defining a guide path allowing the weight 5 to move along the longitudinal direction L towards and away from the cutting cylinder 4, can be achieved in many different ways, such that using a cylinder in which the weight 5 can move and/or using more than one parallel pole 1, and that the solution shown in the Figures is merely an example.

As mentioned, the weight path has a first endpoint and a second endpoint. The first endpoint, defining a location of the weight 5 furthest away from the cutting cylinder 4, is shown in FIG. 1b, while the second endpoint, defining a location of the weight closest to the cutting cylinder 4, is shown in FIG. 1a.

In the example shown in the Figures, the weight path is a straight path through space, arranged to be vertical or at least substantially vertical when operating the device 30. This is the preferred case, with the purpose of maximising the striking impact of the weight 5 onto the cutting cylinder 4. However, it is understood that the weight path can also be curvilinear.

Furthermore, the device 30 comprises a weight propulsion device, arranged to propel the weight 5 reciprocally along said weight path between said first endpoint and said second endpoint, so that the weight 5 strikes against the cutting cylinder 4 when the weight 5 is at a location along said weight path, whereby the striking impact of the weight 5 onto the cutting cylinder 4 in turn urges the cutting cylinder 4 to move in the longitudinal direction L (downwards, towards and into the soil). Hence, while striking the cutting cylinder 4, the weight will typically not fully reach the lower endpoint during its reciprocal movement along the weight path.

It is preferred that the weight propulsion device drives the weight 5 in a reciprocal manner along said weight path, towards and away from the cutting cylinder 4 along the longitudinal direction L. Hence, the weight propulsion device preferably applies a lifting force to the weight 5 on its way away from the cutting cylinder 4, lifting the weight 5 upwards along the weight path.

It is also preferred that the weight propulsion device applies a driving force to the weight 5 in addition to gravity, so that the weight 5 is accelerated towards the cutting cylinder 4 before striking the latter at an acceleration which is larger than the acceleration of gravity along the weight path.

The device 30 may furthermore comprise a soil expulsion piston 9, which is movable inside the cutting cylinder 4 along said longitudinal axis. In particular, the soil expulsion piston 9 is movable inside the internal cylinder space accommodating said cut cylindrical piece of soil, and is arranged to push said soil cylinder out from the cutting cylinder 4, through said open lower end of the cutting cylinder 4. In the exemplifying embodiment illustrated in the Figures, the soil expulsion piston 9 comprises a central axis, arranged to be parallel with the longitudinal direction L (and also parallel with said soil expulsion piston 9), connected to and arranged to drive a circular plate for pushing the soil cylinder out. The circular plate may have a shape complementary to, and of slightly smaller size as, a cross-section of said internal cylindrical space of the cutting cylinder 4.

In some embodiments, the device 30 also comprises a soil expulsion piston 9 driving mechanism, arranged to drive the soil expulsion piston 9 to push out the cut soil cylinder from the cutting cylinder 4.

Hence, the soil expulsion piston 9 driving mechanism may be arranged to transfer a force to the soil expulsion piston 9 to in turn drive the soil expulsion piston 9 in a direction towards said open end of the cutting cylinder 4.

Furthermore, the device 30 may comprise an expulsion activating mechanism, arranged to switch the soil expulsion 9 piston driving mechanism on and off by engaging and disengaging, respectively, said piston driving mechanism.

Hence, the device 30 may have at least two modes of operation – a cutting cylinder 4 driving mode, in which the device 30 is operable for driving the cutting cylinder 4 down into the soil by the weight 5 repeatedly striking onto the cutting cylinder 4 as described above (“cutting mode”); and a soil expulsion mode, in which the device 30 is operable for expelling the cut soil cylinder out from the cutting cylinder by allowing a soil expulsion mechanism, such as the same driving mechanism that drives the weight 5, to push the soil expulsion piston 9 to expel said soil cylinder as described above (“expulsion mode”). By activating a corresponding activating mechanism, a user of the device 30 can then switch between these two modes.

The soil expulsion piston 9 driving mechanism can be arranged to move the soil expulsion piston 9 to drive the soil cylinder out in a manner in which the soil expulsion piston 9 is mechanically connected to the weight 5 or not. In other words, as the soil expulsion piston 9 moves along the longitudinal axis L it may move with the weight 5 or independently of the weight 5, as the case may be.

Hence, in some embodiments the present solution combines a hole cutting and soil expulsion mechanism in one and the same device 30, which can be designed to be compact and sufficiently lightweight for being carried around for hand use on a golf course. It can also provide sufficient power to be able to quickly both cut a new hole and then to expel the cut-up soil cylinder. In fact, the present inventors have successfully cut a golf-type hole in grass turf in less than 10 seconds using a device 30 of the type illustrated in FIGS. 1a-4, and they have also pressed out the resulting soil cylinder in less than 5 seconds. The device 30 can be constructed to weigh at the most 10 kg, and a 4 Ah battery operating at 18V can be caused to last for moving at least 18 holes when used to operate both the cutting cylinder 4 and the soil expulsion piston 9.

In general, about 10 to 25 strokes are required to reach a sufficient depth, depending on the properties of the soil, the mass of the weight 5 and so forth.

As illustrated in FIGS. 1a and 1b, the weight 5 may be propelled reciprocally and repeatedly between the uppermost position shown in FIG. 1b, via an intermediate position, to the lowermost position shown in FIG. 1a, and then back to the position shown in FIG. 1b via the intermediate position.

The metal pole 1 may be rigidly connected to the cutting cylinder 4, so that the entire device 30 moves downwards with the cutting cylinder 4 as the weight 5 moves in relation to the metal pole 1 and strikes the cutting cylinder 4 from above.

The exemplifying device 30 illustrated in the Figures furthermore comprises a top handle 13, arranged to allow a user control the orientation of the device 30 during operation thereof. The top handle 13 may be rigidly connected to the cutting cylinder 4, such as via the metal pole 1.

In some embodiments, the total longitudinal direction L weight 5 amplitude, in other words the longitudinal direction L distance between the first and second endpoints of the weight 5 along the weight path, may be between 50 and 200 mm, such as between 70 and 120 mm.

In some embodiments, the total longitudinal direction L weight 5 amplitude may be at least 50 mm, such as at least 70 mm or even at least 80 mm.

In some embodiments, the total longitudinal direction L weight 5 amplitude may be at the most 200 mm, such as at the most 150 mm or even at the most 100 mm.

In order to maximize the striking impact of the weight 5 onto the cutting cylinder 4, it is preferred that the weight 5, when striking the cutting cylinder 4, is located at the most 10 mm from the lower second endpoint of the weight 5 along the weight path.

The weight 5 may weigh at least 0.5 kg, such as at least 1 kg, 2 kg, such as at least 3 kg. The weight 5 may weigh at the most 10 kg, such as at the most 7 kg. In preferred embodiments, the weight weighs about 4-5 kg. As mentioned, it is preferred that the device 30 in total weighs at the most 10 kg.

The device 30 comprises a first electric motor 7, arranged to drive a drive axle 18 to rotate about a rotary axis 18a under influence of a rotary force provided by the first electric motor 7.

The weight propulsion device further comprises a spring means 50, in turn arranged to be activated, in a first stage and against a spring force of the spring means 50, whereby a potential energy is stored in the spring means 50. In other words, a force provided via the weight propulsion device, and in particular by the first electric motor 7, is used to mechanically press the spring means 50, against a corresponding spring force, so as to create tension in the spring means 50, the tension giving rise to a potential energy increase being stored in the form of a maintained tension in the spring means 50. The tension is maintained due to the spring means 50 being kept in a tensioned state due to the force being provided by the weight propulsion device being maintained.

51 denotes a locking ring for the spring means 50, in the example shown in FIGS. 1a and 1b being a metal spiral spring.

Moreover, the weight propulsion device is arranged to, in a second stage, release said potential energy by relaxing the spring means 50 and to thereby transform the potential energy into kinetic energy of the weight 5 striking against the cutting cylinder 4. Hence, in the second stage the tensioned spring means 50 is allowed to move, under the influence of its spring force, towards an initial state prevalent before the first stage, and as a result drive the weight 5 towards and eventually against the cutting cylinder 4 so as to drive the latter into the ground. This driving may otherwise be as described above.

The impulse applied by the spring means 50 to the weight during the second stage is preferably larger than an impulse that is available via only a hypothetic direct and immediate action of the first electric motor 7, delivered by the weight propulsion device, to the weight 5. In other words, the first stage may represent an energy build-up stage, in which a potential energy is stored in the spring means 50 that is then released, during the second stage, at a power which is higher than a power that the first electric motor 7 itself can instantaneously achieve, so as to drive the weight 5 at this power.

This provides a powerful and efficient, yet relatively quiet, drive of the device 30.

In some embodiments, the first stage is longer, in time, than the second stage. In other words, the energy build-up may be ongoing during a longer time than the release of the built-up energy.

In order to drive the weight 4 repeatedly towards impact with the cutting cylinder 4, the weight propulsion device may be arranged to alternatingly perform said first stage and said second stage, as a result driving the weight 5 to repeatedly strike against the cutting cylinder 4. This striking, driven by the first electric motor 7, may be performed at a frequency of at least 2 strikes per second, such as at least 3 strikes per second, such as at least 4 strikes per second. The present inventors have foreseen striking frequencies up to about at the most 30 strikes per second, such as at the most 20 strikes per second. The spring means 50 and the first electric motor 7 are preferably dimensioned for the weight 5 to deliver an impulse to the cutting cylinder 4, the impulse being large enough for the cutting cylinder 4 to be driven down to a final desired depth in 20-80 strikes, such as 30-60 strikes. Each strike preferably offsets the cutting cylinder between 1 and 4 mm downwards. It is realised that the device 30 may need to be dimensioned for an intended type of soil, but at the same time that the soil of golf greens in general can be expected to be relatively homogeneous and similar across different golf greens.

The device 30 further comprises a force mediating device 8, arranged to, during the first stage discussed above, engage the drive axle 18 with the spring means 50 to mediate the rotary force from the first electric motor 7 to the spring means 50. This mediation in turn activates the spring means 50 to build up potential energy. During the second stage, the force mediation device 8 is arranged to disengage the drive axle 18 from the spring means 50 to allow the spring means 50 to release the built-up potential energy independently of a rotary movement of the drive axle 18. In particular, this may mean that the spring means 50 causes the weight 5 to be accelerated downwards, towards a strike onto the cutting cylinder 4, in a more powerful manner than what would have been the case if the engagement between the first electric motor 7 and the spring means 50 was still intact and the potential energy stored as the tension in the spring means 50 was to be released in a tempo dictated by the rotary velocity of the axle 18. As will be illustrated in the following, the disengagement may be an active disengagement or a passive disengagement.

In general, the force mediation device 8 is arranged to cause the drive axle 18 and the spring means 50 into engagement for the first stage and out of engagement for the second stage.

Further generally, when the spring means 50 is engaged, a part of the spring means 50 can be arranged to follow a movement of the axle 18, after force mediation of said type in a fully dependent manner. Further generally, when not engaged said part of the spring means 50 can at least have a freedom of movement allowing it to release its potential energy faster than the movement, after force mediation, dictated by the first electric motor 7 in the engaged case.

It is realised that the engagement can be direct or indirect. For instance, in the example shown in FIGS. 1a and 1b, the force mediating device 8 acts on the weight 5, by a pulling device 40 of the force mediating device 8 interconnecting a crank 22 of the force mediating device 8. The weight 5, in turn, is connected to the spring means 50 by the spring means 50 being compressed as the weight 5 is lifted upwards by the pulling device 40.

In particular, the force mediating device 8 can comprise said crank 22, which can be arranged to pivot about said rotary axis 18a about which the drive axle 18 is driven by the first electric motor 7. For instance, the crank 22 can be journalled about the drive axle 18, via bearing 23. Generally, the crank 22 is not connected to the drive axle 18 in such a way so that the crank 22 is directly rotationally driven by the first electric motor 7; it can rather pivot about said rotary axis 18a independently of the electric motor 7.

The force mediating device 8 can also comprise a linear force device, connected to the crank 22 at a distance from said rotary axis 18a so that a pivoting of the crank 22 about the rotary axis 18a results in a displacement, such as an at least partly, or even mainly, vertical displacement, of the linear force device. One example of such a linear force device is said pulling device 40.

The crank 22 can then be arranged to convert the rotary force applied onto the drive axle 18 by the first electric motor 7 into a linear force, such as a completely vertical force or a force that at least has a main component in the vertical direction, applied to the linear force device.

The linear force device, in turn, can then be arranged to apply the linear force to the spring means 50 during the first stage to activate the spring means 50. In the example shown in FIGS. 1a and 1b, the pulling device 40 then lifts the weight 5 during the first stage, and the weight 5 thus compresses the spring means 50 so as to activate it.

Hence, the linear force device can be a pulling device 40, arranged to apply a pulling force to the spring means 50 during the first stage to activate the spring means 50.

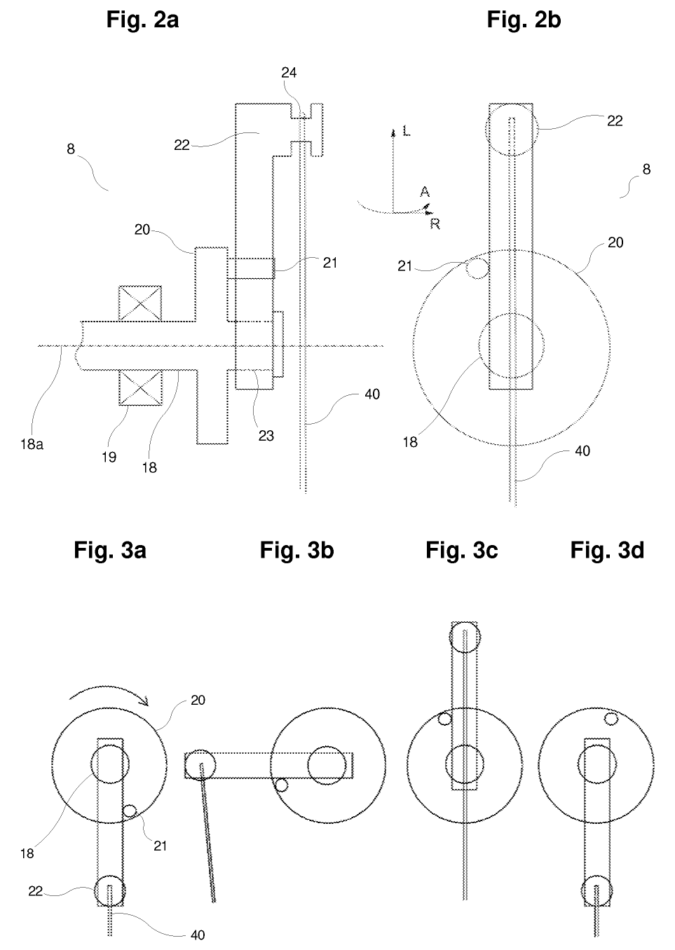

FIGS. 2a-3d illustrate the exemplary method of FIGS. 1a-1b in closer detail, with respect to the force mediating device.

As illustrated in these Figures, the force mediating device can further comprise a drive pin 21. The drive pin 21 can then be eccentrically arranged in relation to the rotary axis 18a and arranged to be forced, by the drive axle 18, to move along a circular path (FIG. 1b) in a plane perpendicular to the rotary axis 18a. The drive pin 21 can further be arranged to push the crank 22 in an angular direction along said circular path, thereby forcing the crank 22 to pivot about the rotary axis 18a as described above.

24 denotes a bearing connecting the end of the pulling device 40 to the crank 22 in a pivotal manner. 19 denotes another bearing, connecting an eccentric disc 20 in a pivotal manner to the drive axle 18. The drive pin 21 is mounted on the eccentric disc 20 in the shown example.

The first electric motor 7 can be arranged to activate the spring means 50 in the first stage by moving the drive pin 21, in turn pushing the crank 22 in said angular direction in a plane perpendicular to the axis 18a. This, in turn, then generates said linear force onto the linear force device.

During the second stage, the spring means 50 can then be arranged to apply a linear force to the linear force device, in turn applying the linear force to the crank 22. Then, the crank 22 as a result pivots ahead of the drive pin 21 about the axis 18a.

It is realised that the linear forces applied onto the exemplifying pulling device 40 illustrated in the Figures always strive to elongate the pulling device 40. Therefore, the pulling device 30 can be a flexible pulling device, such as a string made from metal, plastic or another suitable material. In alternative embodiments, the force mediating device 8 can have other geometric configurations and be positioned above or below the spring means 50 during use of the device 30; and the spring 50 can be a compression or tension spring. Then, the linear forces applied to the linear force device can be pulling and/or compressing forces. In such embodiments, the linear force device can be rigid or flexible, depending on the requirements it needs to meet. It is also foreseen that the linear force device can comprise a piston, a lever, a pneumatic force transfer mechanism, and so forth. Hence, the solution shown in the Figures is particularly simple and simple to construct, but other solutions can be envisioned to achieve the principles described herein.

FIGS. 3a-3d illustrate the operation of the drive pin 21, which can be mounted on the eccentric disc 20 that in turn is driven by drive axle 18.

In FIG. 3a, the crank 22 is directed downwards, and the pulling device 40 in its lowermost position. In this position, the weight 5 is also in its lowermost position, and the spring means 50 is in its most relaxed state.

In FIG. 3b, the drive pin 21 has forced the crank 22 to rotate 90°, pulling the pulling device 40 partly upwards. The weight 5 has been displaced upwards, and the spring means 50 has been compressed partly.

In FIG. 3c, the drive pin 21 has forced the crank 22 to rotate 180° from the state of FIG. 3a, to an uppermost position. In this position, the weight 5 is also in its uppermost position, and the spring means 50 is in its most compressed state. It is noted that the position of the drive pin 21 in relation to the crank 22 illustrated in FIG. 3c is an unstable one.

As the drive pin 21 continues past the position shown in FIG. 3c, the pulling force imparted by the spring means 50 onto the crank 22, via the weight 5 and the pulling device 40, forces the crank 22 to continue pivoting, ahead of the drive pin 21, until it reaches the position shown in FIG. 3d, where the spring means 50 is again in its most relaxed state. This movement, from the state illustrated in FIG. 3c to the one illustrated in FIG. 3d, quickly releases the potential energy stored during the movement from FIG. 3a to FIG. 3c, accelerating the weight 5 downwards into impact with the cutting cylinder 4.

It is noted that the crank 22 can continue ahead of the drive pin 21, from the position illustrated in FIG. 3c to the state illustrated in FIG. 3d, since the crank 22 is not pivotally locked to, but pivotally engaged with, the drive axle 18. To the contrary, the crank 22 cannot lag behind the movement of the drive pin 21, due to the engagement provided thereby as the drive pin 21 catches up with the crank 22.

Thereafter, the drive pin 21 indeed catches up, to again reach the state shown in FIG. 3a, and the cycle repeats. For instance, in case the first electric motor 7 operates at 240 revolutions per minute, the weight 5 will strike against the cutting cylinder 44 times per second.

As is illustrated in the Figures, the spring means 50 can comprise a spiral spring, arranged to be compressed during the first stage. In alternative embodiments, the spring means can comprise a spiral spring arranged to be elongated during the first stage. Correspondingly, the spring means 50 can comprise a compressing/elongating gas spring, or a combination of several spiral and/or gas springs. Generally, the spring means 50 may comprise any number and type of springs, such as one or several gas springs and/or one or several coil springs and/or one or several springs of other types, such as torsion and/or cantilever springs. They may be manufactured from metal, such as steel, or elastomer material.

In general, the spring means 50 can be arranged along the weight path, for instance in the form of a spiral spring arranged around the pole 1. In other embodiments, two springs can be arranged on either side of the weight path.

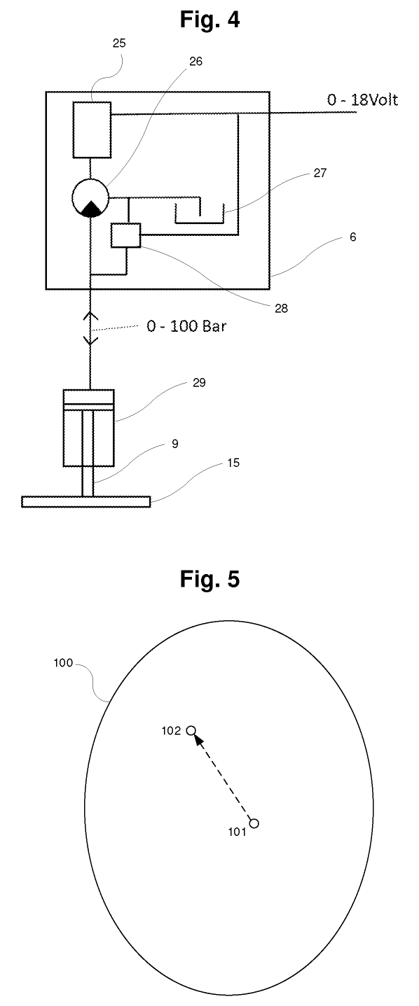

The configuration and operation of the soil expulsion piston 9 is illustrated in FIG. 4, and in particular a soil expulsion device 6. The illustrated soil expulsion piston 9 is a hydraulic piston, driven by a hydraulic pump 26 in turn driven by a second electric motor 25. The soil expulsion piston 9 is provided with pressurized hydraulic fluid, such as oil, by the hydraulic pump 26 to drive the soil expulsion piston 9 so that it in turn presses the soil cylinder out from the cutting cylinder 4 after the cutting cylinder 4 has been lifted from the location where it has been driven down into the soil to create a new hole. 27 denotes a hydraulic fluid tank for the hydraulic fluid.

Expulsion of the soil cylinder from the cutting cylinder 4 can be controlled by an electric valve 28. When no voltage is applied to the valve 28, hydraulic fluid is allowed to flow freely between the hydraulic cylinder 29 and the tank 27. When a voltage, such as 18 V, is applied to the valve 28, the connection to the tank 27 is closed whereby the pump 26 quickly builds up a hydraulic pressure in turn forcing the piston 9 to press the soil out from the cutting cylinder 4. The applied voltage can also cause the second electric motor 25 and the pump 26 to start operating for pressurizing the hydraulic fluid.

In some embodiments, the hydraulic pump 26 is arranged to pressurize the hydraulic fluid when driven by the second electric motor 25, and to allow the pressure of the hydraulic fluid to decrease, preferably to atmospheric pressure or at least to a pressure that is no more than half, or even no more than 10%, of the pressure used to drive out the soil from the cutting cylinder 4, when not driven by the second electric motor 25. This causes the hydraulic fluid both in the tank 27 and in the conduits interconnecting the pump 26, the tank 27, the valve 28 and the hydraulic cylinder 29 to be low at all times apart from when the soil cylinder is being pushed out, in turn resulting in lower risk of hydraulic fluid leakage from the device 30. The pump 26 will quickly build up the required pressure for soil expulsion when activated.

The pressure used to press out the soil from the cutting cylinder 4 can be at least 10 bar, such as at least 50 bar, such as about 100 bar.

In FIGS. 1a and 1b, the first motor 7 and the second motor 25 are shown as two distinct electric motors. However, in some embodiments the first motor 7 and the second motor 25 are one and the same. Then, such common electric motor can be activatable to selectively activate the weight propulsion device or the soil expulsion device. In these and in other embodiments, it is preferred that the weight propulsion device is only driven by the first electric motor 7, with the first electric motor 7 driving the spring means 50 for building up the potential energy directly, without any intermediate hydraulic or pneumatic mechanisms, whereas the soil propulsion device drives the soil expulsion piston 9 only using the hydraulic pressure provided by the second electric motor 25. The soil expulsion piston 9 can be activated for driving out the soil cylinder without any pressure build-up of the hydraulic pressure before the pressure is released to drive out the soil cylinder, but instead under the direct and immediate influence of the pump 26.

Using one and the same electric motor as the first 7 and second 25 motors can be achieved in various ways, such as switching between two different mechanisms to be driven by the drive axle 18 using a gearbox or similar. In some embodiments, the first motor 7 is arranged to only drive the drive axle 18 (activating the force mediating device 8) when driving in a first rotary direction and to only drive the hydraulic pump 26 when driving in a second rotary direction.

This can be achieved, for instance, by a mechanism such as the one shown in FIG. 7, showing the common electric motor 7, the driving the axle 18 and also another axle 66. Note that in FIG. 7, the axle arriving directly from the motor 7 is axle 66, whereas axle 18 is mechanically connected, for rotation, to axle 66. Axle 66, in turn, is arranged to drive the pump 26. Axle 18 is driven by the motor 7 in an opposite direction as compared to the axle 66, via a pair of cooperating and engaging gears 64, 65. 61 denotes bearings. 62 is a freewheel mechanism, arranged to engage with the driving axle 66 when driven in a second direction but to disengage from the driving axle 66 when driven in a first, opposite direction. 63 is a freewheel mechanism, arranged to engage with the axle 18 when driven in the first direction but to disengage from the axle 18 when driven in the second direction. Hence, the motor 7 will drive only the weight propulsion device when driven in the first direction, and drive only the soil expulsion device when driven in the second direction.

It is noted that the motor 7 can comprise a gearbox or similar, arranged to adjust the rotational velocity of the axle 66.

It is realized that the mechanism illustrated in FIG. 7 is one of many possible examples. For instance, instead of two parallel axles 18, 66 as shown in FIG. 7, the motor 7 can instead have one respective parallel axle on either side thereof, with corresponding freewheel mechanisms.

The common motor can be electronically controlled to a desired respective rotation frequency for each rotary direction.

10 denotes a switch using which a user can activate the first electric motor 7 for driving down the cutting cylinder 4 into the ground 100, for instance by driving said common motor in a first rotary direction. 11 denotes a switch using which the user can activate the second electric motor 25 for driving the soil expulsion device, for instance by driving said common motor in a second rotary direction.

As is illustrated in FIGS. 1a and 1b, the device 30 can furthermore comprise a battery 31, arranged to power the first motor 7 and/or the second motor 25, preferably both.

Apart from the first 7 and second 25 electric motors (or the single common electric motor), it is preferred that no other weight propulsion or soil expulsion devices are powered by the battery 31, and preferably there are no additional power sources of the device 30 apart from the battery 31. This way, all of the components comprised in the device 30 may be packaged into one cordless, mobile unit for ease of use when out and about on the golf course, while still being able to provide sufficient power to quickly cut holes as described herein. Such mobile unit is preferably arranged with a weather-proof chassis arranged to enclose all weather-sensitive components of the device 30.

When the user wants to produce a new hole in the ground 100, the device 30 is hence placed in the upright orientation illustrated in FIGS. 1a and 1b, and the first electric motor 7 is activated to drive the weight 5, by activating the first stage and the second stage alternatingly and repeatedly as described above, until a desired hole depth has been achieved. Then, the soil may be expelled by the soil expulsion piston 9, by activating the second electric motor 25.

FIG. 5 illustrates the golf green 100 with an existing hole 101 to be replaced with (“moved to”) a hole 102 to be cut.

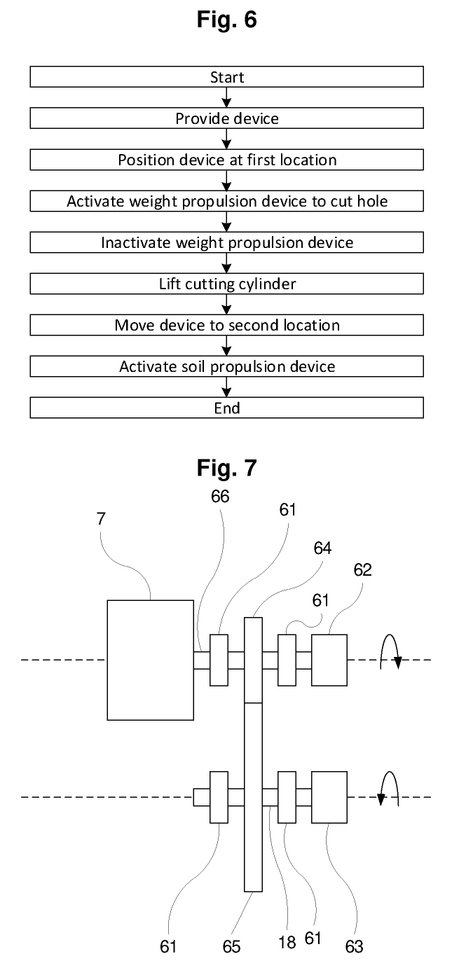

FIG. 6 illustrates a method according to an embodiment of the present invention, for making a hole in a golf green 100, and also for performing such a “moving” of the hole 101 to a new hole 102 location on the green 100.

In a first step, the method starts.

In a subsequent step, a device 30 of the above type is provided. This step may also comprise charging the battery 31 of such a device before use.

In a subsequent step, the device 30 is positioned in a first location 102 on the golf green 100, oriented so that its longitudinal direction L is vertical or at least substantially vertical. The first location 102 is the location where a hole is to be cut, or the location to which an existing hole is to be moved.

In a subsequent step, the weight propulsion device of the device 30 is activated, such as using the switch 10 on the device 30, to move the weight 5 reciprocally upwards and downwards as described above, and as a result repeatedly striking the cutting cylinder 4 by the weight 5 so that the cutting cylinder 4 by each stroke is driven down into the soil of the green 100.

In a subsequent step, when a desired hole depth is reached, the cutting cylinder 4 is lifted upwards, by lifting the entire device 30, thereby removing a resulting soil cylinder from the cut hole. This step may be preceded by the user switching off the weight propulsion device 30.

If the user desires to move a hole in the golf green 100 from said second place 101 to a first place 102, the method may further comprise a subsequent step, in which the device 30 is moved to the second place 101, where a hole already exists in the ground, and positioning the device 30 so that the cut soil cylinder is immediately above and aligned with the existing hole.

In a subsequent step, the weight propulsion device is activated, such as by using switch 11, so that the soil expulsion piston 9 pushes the soil cylinder our from the cutting cylinder 4 and into the existing hole. Therein, the soil cylinder fills the existing hole and provides a grass turf surface.

Then, the method ends. However, the hole cutting and/or moving may be repeated on the same or a different green, indefinitely, as long as the battery keeps its charge.

Above, preferred embodiments have been described. However, it is apparent to the skilled person that many modifications can be made to the disclosed embodiments without departing from the basic idea of the invention.

For instance, the numerous alternatives described above are freely combinable as long as they are compatible.

Also, all which has been said herein in relation to the present device is applicable to the present method, and vice versa.

Hence, the invention is not limited to the described embodiments, but can be varied within the scope of the enclosed claims.

What is claimed is:

1. A device for making a hole in a golf green, the device having a longitudinal direction, a radial direction and an angular direction, comprising:
a cutting cylinder with an axis parallel to the longitudinal direction and an open end being freely movable along the longitudinal direction;
a structure, comprising guide means defining a weight path having a first endpoint and a second endpoint;
a weight, in engagement with said guide means to be guidedly movable along said weight path; and
a weight propulsion device, arranged to propel the weight reciprocally along said weight path between said first endpoint and said second endpoint so that the weight strikes against the cutting cylinder when the weight is at a location along said weight path, in turn urging the cutting cylinder in the longitudinal direction,
wherein weight propulsion device comprises:
a first electric motor, arranged to drive a drive axle to rotate about a rotary axis under influence of a rotary force provided by the first electric motor;
a spring means, arranged to be activated, in a first stage and against a spring force of the spring means, whereby a potential energy is stored in the spring means, and in a second stage to release the potential energy by relaxing the spring means and to thereby transform the potential energy into kinetic energy of the weight striking against the cutting cylinder; and
a force mediating device, arranged to, during the first stage, engage the drive axle with the spring means to mediate the rotary force to the spring means in turn activating the spring means and, during the second stage, disengage, using an active or passive disengagement mechanism, the drive axle from the spring means to allow the spring means to release the potential energy independently of a rotary movement of the drive axle.

2. The device of claim 1, the force mediating device comprising:
a crank, arranged to pivot about said rotary axis; and
a linear force device, connected to the crank at a distance from the rotary axis,
wherein the crank is arranged to convert said rotary force into a linear force applied to the linear force device, and
wherein the linear force device is arranged to apply a linear force to the spring means during the first stage to activate the spring means.

3. The device of claim 2, wherein the linear force device is a pulling device, arranged to apply a pulling force to the spring means during the first stage to activate the spring means.

4. The device of claim 2, the force mediating device further comprising:
a drive pin, the drive pin being eccentrically arranged in relation to the rotary axis and arranged to be forced, by the drive axle, to move along a circular path in a plane perpendicular to the rotary axis, the drive pin further being arranged to push the crank, thereby forcing the crank to pivot about the rotary axis,
wherein the first electric motor is arranged to activate the spring means in the first stage by moving the drive pin, in turn pushing the crank, in turn generating said linear force, and
wherein the spring means is arranged to, during the second stage, apply a linear force to the linear force device in turn applying the linear force to the crank, the crank as a result pivoting ahead the drive pin about the drive axis.

5. The device of claim 1, wherein the spring means comprises a spiral spring arranged to be compressed or elongated during the first stage, and/or a gas spring.

6. The device of claim 5, wherein the spring means is arranged along the weight path, such as around the weight path.

7. The device of claim 1, wherein a total longitudinal direction weight amplitude is between 50 and 200. mm, such as between 70 and 120. mm, and/or wherein a total longitudinal direction weight amplitude is at the most 150 mm, such as at the most 100 mm.

8. The device of claim 1, further comprising:
a soil expulsion piston, arranged to be activated to drive out a soil cylinder out from the cutting cylinder.

9. The device of claim 8, wherein the soil expulsion piston is a hydraulic piston.

10. The device of claim 8, further comprising:
a hydraulic pump driven by a second electric motor, and wherein
the soil expulsion piston is provided with pressurized hydraulic fluid, such as oil, by said hydraulic pump.

11. The device of claim 10, wherein the hydraulic pump is arranged to pressurize the hydraulic fluid when driven by the second electric motor, and to allow the pressure of the hydraulic fluid to decrease, preferably to atmospheric pressure, when not driven by the second electric motor.

12. The device of claim 10, wherein the first motor and the second motor are one and the same.

13. The device of claim 12, wherein the first motor is arranged to only drive the drive axle when driving in a first direction and to only drive the hydraulic pump when driving in a second direction.

14. The device of claim 1, further comprising
a battery, arranged to power the first motor and/or the second motor.

15. A method for making a hole in a golf green (100), comprising:
providing a device according to claim 1;
positioning said device in a first location on the golf green oriented so that its longitudinal direction is vertical;
activating the weight propulsion device to move the weight reciprocally and as a result repeatedly striking the cutting cylinder so that the cutting cylinder by each stroke is driven down into the ground; and
when a desired hole depth is reached, lifting the cutting cylinder upwards, thereby removing a resulting soil cylinder from the hole.

16. A method for moving a hole in a golf green from a second location to a first location, comprising the steps of claim 15 and further comprising:
positioning the device at the second location, at which a hole already exists in the ground; and
activating a soil expulsion device of the device so that a soil expulsion piston of the device pushes the soil cylinder our from the cutting cylinder and into the existing hole.
